(19) United States
(12) Patent Application Publication
(10) Pub. No.: US 2004/0078208 A1
(43) Pub. Date: Apr. 22, 2004

(54) Tracking system

(76) Inventor: Malcolm Burwell, Lexington, MA (US)

Correspondence Address: Finnegan, Henderson, Farabow,, Garrett & Dunner, L.L.P., 1300 I Street, N.W., Washington, DC, 20005-3315, US

(21) Appl. No.: 10/273,290

(22) Filed: Oct. 18, 2002

(51) Int. Cl. G06F 17/60; G09B 9/04; G09B 19/16

(52) U.S. Cl. 705/1; 434/64

(57) ABSTRACT

A race simulation system is provided for remotely simulating a race between a plurality of participants. The simulation system includes a tracker for tracking the position of the participants as they move during the race and for generating corresponding positional data. This positional data is then transmitted through a communications channel to one or more remote users. Each remote user has a terminal which is operable to recreate a simulation of the race using the received positional data and stored layout data which defines the layout of the course over which the participants move.

This invention relates to tracking participants in a race or other competitive sporting activity and providing information about the performance of the participants to a remote user in real time and allowing the user to place bets on the sporting activity.

There is in existence an on-line internet betting system which provides live video feeds from a number of horse racing tracks to a user and which also allows bets to be placed on horses on-line via the internet at the betting shops which own the on-line betting system. This system has two main drawbacks. The first is that transmitting live video streams requires a level of bandwidth which is beyond the capabilities of the internet connections of most home users. Thus, this system provides little benefit over a simple internet connection to a betting service as the video feeds will typically be very jerky and too small in size to be of any use.

The second drawback of this known system is that the video signals received are limited to the camera angles and subject chosen by the service provider. Thus, the user of the system is only able to watch those horses which the service provider chooses to transmit pictures of.

There also exists a company which collates data gathered on video at a number of horse racetracks, processes the various video streams and then transmits the processed streams from all of the racetracks to each racetrack so that persons at any racetrack can see and bet on races at any other racetrack. This is achieved by transmitting the video streams to and from the racetracks via satellite links which, again, requires a large amount of bandwidth. This is therefore expensive, as bandwidth on a satellite link is expensive.

The present invention has been made with the above identified problems in mind.

Embodiments of the present invention will now be described, by way of example only, with reference to the accompanying figures in which:

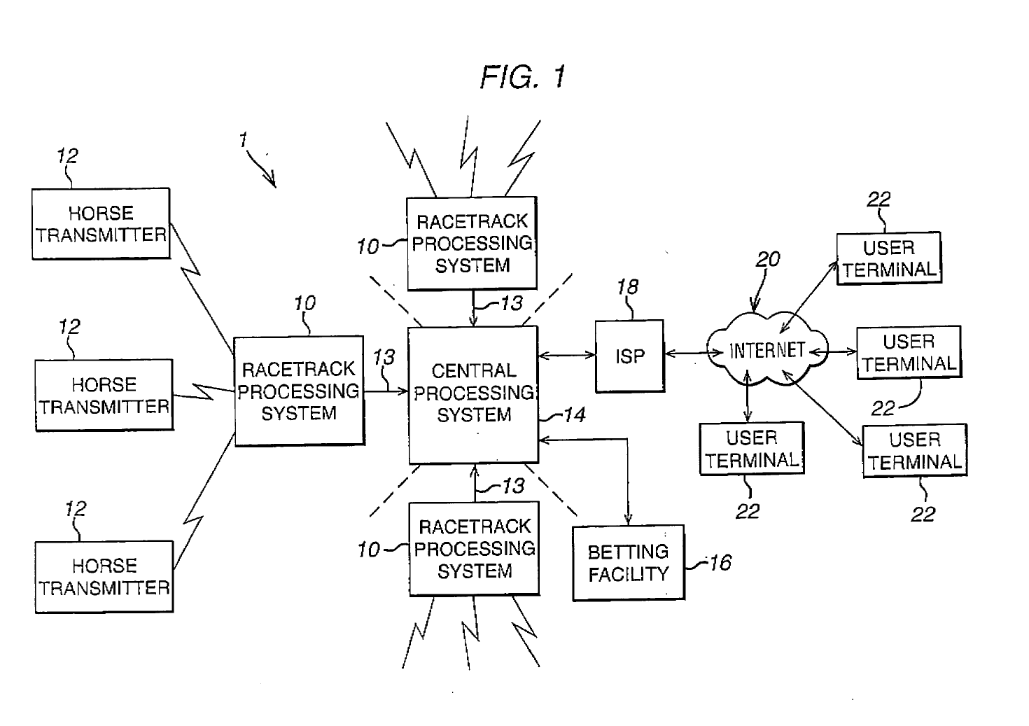

FIG. 1 shows a block diagram of the functional components of a graphical racing system;

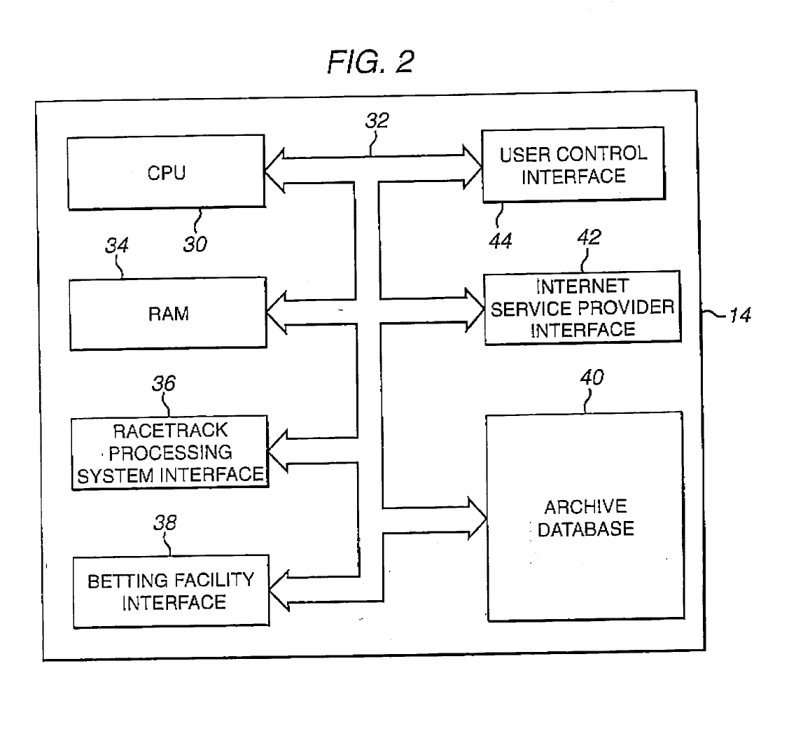

FIG. 2 shows a block diagram of the functional components of the central processing system of the graphical racing system of FIG. 1;

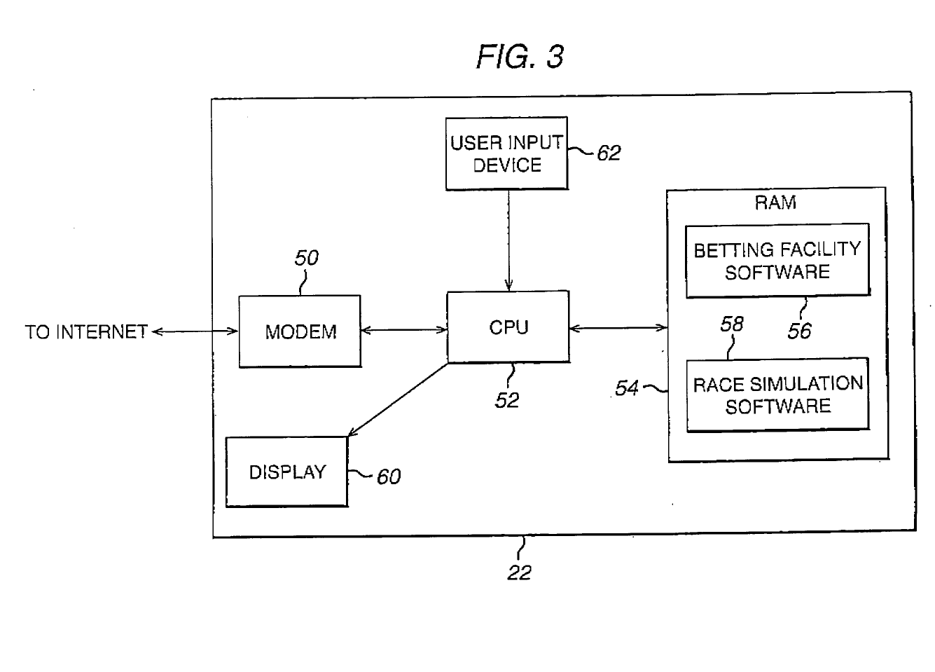

FIG. 3 shows a block diagram of the functional components of the user terminal of the graphical racing system of FIG. 1;

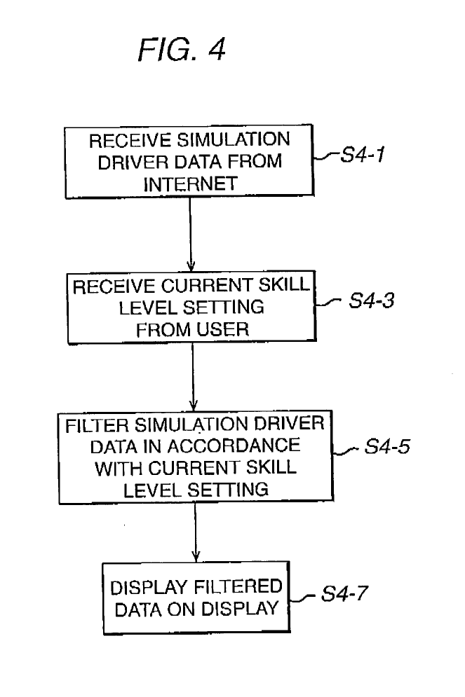

FIG. 4 shows a flow diagram of the operation of a skill level function in the user interface.

Referring to FIG. 1, the graphical racing system 1 comprises a central processing system 14 which collects data from individual racetrack processing systems 10 and transmits that data over the internet 20 via an internet service provider 18 to a number of users at user terminals 22. The users at the user terminal 22 can transmit betting requests over the internet 20 to the central processing system 14 for handling by a betting facility 16.

Each racetrack processing system 10 is located at an individual racetrack. The racetrack processing system 10 comprises a tracking system for tracking horses as they move around the race track. In this embodiment, the tracking system is a private radio system which works by receiving signals from transmitters 12 attached to each of the horses and processing the signals from the horse transmitters 12 to determine the position of each of the horses. In this embodiment, the tracking system takes new readings to update the positions of the horses twenty times per second. The racetrack processing system 10 then formats this position data to be in a suitable form for use by the central processing system 14 which is located remote to the track. In addition to the horse position data, the racetrack processing system 10 also collects non-position data, including horse characteristics (colour, size, gait style), jockey characteristics (colour of silks, size, typical gestures and stance), and variable racetrack information (track condition, weather, crowd size) etc. The racetrack processing system 10 does not only collect data about horses currently racing, it also collects data about horses being exercised and “worked out” in practice runs. The racetrack processing system then transmits the horse position data, the non-position data and the horse exercise data to the central processing system 14 via a datalink 13, such as a satellite link.

The central processing system 14 receives the horse position data, the non-position data and the horse exercise data from all the connected racetrack processing systems 10 and processes the data for storage and onward transmission to users.

In this embodiment, the processed horse position data and non-position data in the central processing system 14 is transmitted to an internet service provider 18 so that the data can be accessed over the internet 20. Individual users at user terminals 22 are able to access the data across the internet 20 so as to be able to follow each race as it progresses. The user at the user terminal 22 may also place bets on horses in any of the races across the internet 20. The betting request from the user terminal 22 is transmitted to the internet service provider 18 via the internet 20 and then from the internet service provider 18 to the central processing system 14. The central processing system 14 then passes on the betting request to the betting facility 16 where the bet can be recorded.

At each user terminal 22, the horse position data and non-horse position data are used together with race simulation software which includes a 3D model of each racetrack to allow the user to watch a simulation of the race as though on video at the user terminal 22.

Referring to FIG. 2, the functional elements of the central processing system 14 will now be described in more detail. Controlling the system is a central processor unit (CPU) 30. The CPU 30 communicates with other parts of the system 14 via a data bus 32. Connected to the data bus 32 is a memory 34 in which all of the software used by the central processing system 14 is run. Also connected to the data bus 32 is a racetrack processing system interface 36 which receives data from each racetrack processing system 10. Also connected to the bus 32 is a betting facility interface 38 which allows data to be transmitted to and received from the betting facility 16. An archive database 40 is also connected to data bus 32 for storing all the data received from the racetrack processing systems 10 via the racetrack processing interface 36 and for storing other information input by a system controller via the user control interface 44. An internet service provider interface 42 is also provided connected to data bus 32 for sending and receiving data to and from the internet service provider 18.

The horse position data, non-position data and the horse exercise data is received from each racetrack processing system 10 by racetrack processing system interface 36. This data is processed by CPU 30 using processing software in memory 34 to be suitable for transmission to a user via the internet 20. More particularly, the horse position data and non-position data are processed for immediate transmission to the user terminals 22 so that the user terminals 22 receive the race data immediately. Data about horses not currently racing and the horse position data is processed to create performance data for each horse, which performance data is transmitted to the internet service provider 18 and stored on the archive database 40 along with the data received from the racetrack processing system 10.

The data stream transmitted to the user terminals 22 thus comprises data about races currently happening, so that the user terminals 22 can reconstruct the race in real time, and performance data for all horses recorded in the system, whether or not they are actually racing at the time of data transmission, so that the user can view the performance history of each horse to decide on how best to place any bets. This transmitted data stream is known as Simulation Driver Data.

In addition, the betting facility 16 transmits data on the odds and prices to be offered in future and ongoing races to the central processing system 14 to be included with the Simulation Driver Data for transmission to the user terminals 22 via the internet service provider 18 to be used by the user in making betting decisions.

Referring again to FIG. 1 the internet service provider 18 then makes the Simulation Driver Data from the central processing system 14 available over the internet 20 and users at user terminals 22 are able to access that data. The connection between the internet service provider 18 and the user terminals 22 is preferably a Virtual Private Network formed over the internet to enhance the security, speed and quality of the internet connection. A Virtual Private Network is a system for providing facilities normally associated with a Private Telecommunications Network over a public network such as the internet. Software for setting up a Virtual Private Network is widely commercially available. Furthermore, the Simulation Driver Data may be advantageously provided as a push-stream of data using protocols such as RTSP (real time streaming protocol) or RSVP (real time stream reservation protocol) which are freely available at no cost to the user.

Referring now to FIG. 3, the functional components of the user terminal 22 will now be described in more detail. In this embodiment, the user terminal 22 is a personal computer. The Simulation Driver Data from the internet is received at the user terminal 22 by a modem 50 for use by a central processor unit (CPU) 52. As stated above, the Simulation Driver Data received by the modem 50 comprises race data (horse position data and non-horse position data), non-race horse data and betting data. The CPU 52 accesses software in a memory 54 to display the data on a display 60 in accordance with commands input by the user via a user input device 62.

More particularly, stored within the memory 54 is betting facility software 56 which the CPU 52 uses to interpret the betting data received by the modem 50 and race simulation software 58 which is used by the CPU 52 to interpret the race data and non-race data received by the modem 50.

The race simulation software 58 allows the CPU 52 to construct on the display 60 a computer simulation of each race as it progresses. The race simulation software 58 includes a 3D model of each racetrack to which the race data for each racetrack can be applied, such that images representative of the crowd, the grandstand, the current weather conditions at the racetrack and the colour and size of each horse and jockey can be constructed in real time on the display 60. Further, using the horse position data, the horses in the model can be animated to reconstruct the race. Since the simulation driver data does not actually include video data, but only relatively low bandwidth position data, the computer simulation of the race can be performed substantially in real time. Additionally, since the race simulation software uses a 3D model of the racetrack to generate the background of the racetrack, the user is able to select the required viewing conditions by directing the camera position, viewing direction and field of view (zoom) as he or she wishes. This therefore allows the user to focus on any particular horse or group of horses in the race or on an overall view of the race. Thus the user is given total flexibility in how they wish to view the race as it progresses.

In addition to the race display generated from the race data, the user terminal 22 is also able to display the performance history data for each horse so that experienced gamblers can make informed choices concerning the placing of bets. In a preferred embodiment, the race simulation software includes a number of user setable “skill levels”. In the lowest skill level, which is intended for novices, the user is shown no information on the performance history of the horses and is shown just the odds for each horse. However, as the skill level increases, so the amount of performance history data and other pertinent data is made available to the user. In this way, users who are more familiar with horse betting can receive the performance data and other data which will allow them to place an informed bet, whilst novice users can enjoy the experience of simply placing a bet based on the odds and without being overwhelmed by the performance history data and other data that can affect the race.

FIG. 4 shows an exemplary flow chart which is used to control the filtering of the data in this embodiment. As shown, at step s4-1, the simulation driver data is received from the internet via the modem 50. Next, at step s4-3, a current skill level setting is received from the user (which is stored in the RAM 54 and which is set by the user via the user input device 62). At step s4-5, the processor then filters the simulation driver data in accordance with the current skill level setting. Finally, at step s4-7, the filtered data is displayed on the display 60 so that the user is given the required data.

Referring again to FIG. 3, in order to place a bet, the user enters, via the user input device 62, the amount of money to be bet, the type of bet, and the horse(s) on which the bet is to be placed. In response, the betting facility software 56 ask the user to confirm the details of the bet and, following confirmation transmits the bet to the betting facility 16 via the internet 20 and the central processing system 14. When transmitting the bet, the betting facility software 56 transmits user ID information which allows the betting facility 16 to identify the user that has placed the bet. Upon receipt of the betting request, the betting facility 16 processes the request to ensure that it is a valid betting request submitted by a valid user. If it is, then the betting facility accepts the bet and transmits an acknowledgement back to the user via the central processing system 14 and the internet 20. The acknowledgement is then displayed to the user on the display 60 confirming that the bet has been accepted. Payment of winnings on a bet may be made by crediting a betting account held by the user, in the same way that payment of the bet is achieved by debiting that account. Alternatively, all payments may be made by instant money transfer techniques such as Electronic Funds Transfer (EFT) using credit or debit cards.

Thus the graphical racing system 1 provides a user with a low bandwidth system for being able to watch a race substantially in real time, using camera angles defined by the user, and being able to place bets on horses competing in that race.

Many modifications are possible to the embodiment described above.

Although it has been described with respect to the above embodiment that the graphical racing system 1 is used with respect to horse racing, it is not limited thereto and it may be applied to any sporting activity including but not limited to dog racing, motor racing and team sports such as football.

It has been described with reference to FIG. 1 that the racetrack processing system 10 utilises a private radio tracking technique to track the positions of the horses. Alternatively, each horse may be equipped with a global positioning system (GPS) receiver and a data transmitter to transmit the data from the GPS receiver to the racetrack processing system such that each horse transmitter “knows” where it is and transmits this data to the racetrack processing system 10. Alternatively to GPS, GLONASS (the Russian equivalent to GPS) or GNSS (a proposed new satellite navigation system) could be used. As a further alternative, a video system that extracts location through video processing could be used.

Although it has been described in the above embodiment that data is transmitted from the racetrack processing system 10 to the central processing system 14 via a satellite datalink, it is possible for this data to be transmitted via a standard subscriber phone line, or via a private network. The satellite data link is however favourable due to its higher availability and speed of transmission.

Although it has been described in the above embodiment that non-horse position data is transmitted from the racetrack processing system 10 to the central processing system 14, this is not essential to the operation of the invention and may be omitted.

The internet service provider 18 need not be a separate commercial or physical entity to the central processing system 14 and may be an integral part thereof. Similarly, the betting facility 16 need not be a separate commercial and physical entity to the central processing system 14 and may be a component thereof, although this typically requires regulatory approval and has legal consequences.

Although it has been described above that the central processing system 14 is implemented using a single CPU, a system which distributes the processing load over multiple CPU's is also possible.

Although it has been described in the above embodiment to transmit data from the central processing system 14 to user terminals 22 via the internet 20, is also possible to transmit this data via a private network or via a satellite data link.

Although it has been described above that a user's bets are transmitted to a betting facility 16, it is also possible to transmit the user's bets to one or more of a multiplicity of betting facilities. Such multiple betting facilities give the user access to a choice of odds or may be required by law, for example because of the user's geographical location. Furthermore, communication with the betting facility(s) may also take place via an ISP 18 and the internet 20.

Although it has been described with reference to FIG. 3 that the user terminal 22 comprises a personal computer, the user terminal 22 may comprise a games console (such as the Sega Dreamcast which has a modem built in), a set top box (such as those provided by cable television companies) or a purpose designed kiosk which may be in the users home or at a public location (for example at a racetrack or offsite betting facility).

Although it has been described in the above that a user can use the graphical racing system 1 to place simple bets on horses, other more exotic bets can also be placed, such as bets on horse times, stables, trainers or jockeys in combinations.

Although it has been described with reference to the above embodiment that additional data (comprising performance data from the horse tracking system gathered during daily exercise and historical performance of horses in earlier races) is added to the processed data from the central processing system 14, this is not essential to the operation of the invention and may be omitted.

As an alternative to the above described embodiment where a user at a user terminal 22 is able to place real bets on horses using the graphical racing system 1, it is possible to allow a user to place a dummy bet using imaginary money to allow users to be able to practice betting and practice analysing the race and horse data without the risk of losing real money on the bet.

The race simulation part of the graphical racing system 1 described above does not require the existence of the betting system to function. That is, it is possible to simply provide the system as described above but without the betting facility 16 and the betting facility software 56 such that a user can simply watch a race at their terminal using the race simulation software 58. It is also possible that the race data transmitted to the user may be used for activities other than simply watching a race and placing bets. In particular, it is possible that the data could be collected by a virtual game administrator for use in virtual race gaming. In virtual race gaming, data for each horse is analysed and processed to create a virtual horse based on that data. Players of the virtual race game may either enter their own virtual horses based on their own horses or may use virtual horses created from the race data to race against virtual horses being used by other virtual race gamers. This facility would be particularly applicable to a game such as golf where an individual player could create a virtual golfer based on their own golfing ability and equipment and their virtual player could then play against virtual players belonging to other gamers and against virtual players generated from data collected from professional golf tournaments.

As discussed above, there is a company which collects data gathered on video at many horserace tracks, processes the various video streams and then transmits the processed streams from all of the racetracks to each racetrack. In addition to transmitting the race data to the users, this data could also be transmitted direct to the company such that the company would be receiving a low bandwidth data stream rather than a high bandwidth video stream to enable them to carry on their business at a fraction of the cost incurred by sending video via satellites data links.

In addition to the user terminals 22 described above, some terminals may be provided which simply collect the race data for a simulation and analysis so that the user can place an informed bet, either via the graphical racing system 1 or in a more traditional way.

It has been described in the above embodiment to place bets on races which are being run at the time. It is also possible to allow a user to place bets on future races. To facilitate this the betting facility 16 would keep a database of races to be run in the future, along with details of the entrant horses. This database would be available to the user terminals 22 either by inclusion in the Simulation Driver Data, or as a separate download available in response to a specific request.

The simulation driver data received by the user terminal 22 can be stored at the user terminal 22 on a long term storage medium such as a hard disk drive (not shown). This data could then be used to construct virtual races to try to predict the winner of a future race by using performance data about each of the horses to be racing in the future race to animate the horses in the virtual race.

The graphical simulation of the race in the user terminal 22 may be simpler than a full 3D-video simulation. At the simplest level, the simulation could display a number of dots moving around a circle, with each dot corresponding to an individual horse.

The system for providing varying amount of past performance information about each horse at the user terminal 22 in accordance with a user skill level is also applicable to the above described prior art system in which video data is transmitted to the user.

I claim:

1. A race simulation system for remotely generating a simulation of a race between a plurality of participants which move from a start position to an end position on a racing course, the simulation system comprising:
means for tracking the position of the participants as they move from the start position to the end position and for generating corresponding positional data for each of the participants;
means for transmitting said positional data to a communications channel; and
a user terminal comprising:
means for receiving the positional data transmitted through said communications channel; and
means for generating and outputting a simulation of the race using said received positional data.

2. A race simulation system according to claim 1, wherein each participant carries a transmitter for transmitting a locator signal and wherein said tracking means comprises:
(i) means for receiving the locator signal from each participant; and
(ii) means for processing the received locator signals to determine positional data for each participant.

3. A race simulation system according to claim 1, wherein each participant carries a positioning system and wherein said tracking means comprises means for receiving positional data transmitted from the positioning systems carried by each of the participants.

4. A race simulation system according to claim 1, wherein the means for tracking the position of the participants and for generating corresponding positional data for each of the participants comprises:
(i) means for gathering video data of the race; and
(ii) means for processing the video data to extract positional data for each participant therefrom.

5. A race simulation system according to claim 1, wherein said communications channel comprises the Internet.

6. A race simulation system according to claim 1, wherein said communications channel is a virtual private network formed across the Internet.

7. A race simulation system according to claim 1, wherein said transmitting means forms part of a central simulation system which is operable to receive positional data corresponding to participants in a plurality of different races taking place at different locations, and wherein said transmitting means is operable to transmit positional data of said different races to said communications channel.

8. A race simulation system according to claim 1, wherein said means for outputting a simulation of the race is operable to output the simulation on a display.

9. A race simulation system according to claim 1, wherein said user terminal comprises a memory for storing data defining the layout of the racing course and wherein said generating and outputting means is operable to use said stored data to generate said simulation.

10. A race simulation system according to claim 9, wherein said stored data is in the form of a 3D model and wherein said generating and outputting means is operable to generate a 3D video type simulation which is displayed to the user on a display.

11. A race simulation system according to claim 1, further comprising means for generating betting data and wherein said transmitting means is operable to transmit said betting data to said communications channel, and wherein said user terminal is operable to output the betting data to the user and comprises means for receiving a betting request input from the user based on the output betting data.

12. A race simulation system according to claim 11, wherein said user terminal further comprises means for receiving an input from the user for selecting a betting preference setting; and means for filtering the received betting data in dependence upon the selected betting preference setting and for outputting the filtered betting data to the user.

13. A simulation system according to claim 11, wherein said user terminal further comprises means for transmitting the betting request input from the user to said communications channel and further comprising a betting facility for receiving the betting request transmitted through the communications channel for administering the bet.

14. A simulation system according to claim 12, wherein said user terminal further comprises means for transmitting the betting request input from the user to said communications channel and further comprising a betting facility for receiving the betting request transmitted through the communications channel for administering the bet.

15. A race simulation system according to claim 13, wherein said betting facility comprises accounting means for accounting for the bets in dependence upon the betting request and upon the result of the race.

16. A race simulation system according to claim 15, wherein said accounting means is operable to debit or credit an account associated with the user who transmitted the betting request in dependence upon the result of the race.

17. A race simulation system according to claim 11, wherein said betting data includes odds for each of the participants and performance data for each of the participants in previous races.

18. A race simulation system according to claim 1, wherein the race is a horse race.

19. A race simulation system according to claim 1, wherein said race is a dog race.

20. A race simulation method for remotely generating a simulation of a race between a plurality of participants which move from a start position to an end position on a racing course, the method comprising:
tracking the position of the participants as they move from the start position to the end position and for generating corresponding positional data for each of the participants;
transmitting said positional data to a communications channel;
receiving the positional data transmitted through said communication channel at a user terminal; and
generating and outputting a simulation of the race using said received positional data at said user terminal.

21. A betting system for allowing a remote user to place a bet on the outcome of a contest, the system comprising:
means for generating contest data indicative of the progress of the contest;
means for transmitting the contest data and betting data to the remote user through a communications channel; and
a user terminal associated with the remote user comprising:
means for receiving the contest data and the betting data from said communications channel;
means for outputting the contest data received from the communications channel to said user;
selecting means responsive to an input from the user for selecting a betting preference setting;
means for filtering the received betting data in dependence upon the selected betting preference setting and for outputting the filtered betting data to the user; and
means for receiving a betting request from the user.

22. A betting system according to claim 21 further comprising a betting facility for generating the betting data to be transmitted to the remote user and wherein said user terminal further comprises means for transmitting the betting request to said betting facility through said communications channel.

23. A betting system according to claim 21, wherein said betting data includes the odds on outcomes of the contest and past performance data relative to the contestants.

24. A betting system according to claim 21, wherein said filtering means is operable to filter said performance data in dependence upon the selected betting preference setting.

25. A betting system according to claim 21, wherein said contest is a race between a plurality of participants.

26. A betting system according to claim 25, wherein said race is a dog race or a horse race.

27. A system according to claim 21, wherein said communications channel comprises the Internet.

28. A system according to claim 21, wherein said contest data comprises positional data indicative of the position of contestants during the contest.

29. A system according to claim 21, wherein said contest data comprises video data of the contest.

30. A betting method for allowing a remote user to place a bet on the outcome of a contest, the method comprising;
generating contest data indicative of the progress of the contest;
transmitting the contest data and betting data to the remote user through a communications channel;
receiving the contest data and the betting data from said communications channel at a user terminal associated with the remote user;
outputting the contest data received from the communications channel to said user at said user terminal;
receiving an input from the user at the user terminal for selecting a betting preference setting;
filtering the received betting data in dependence upon the selected betting preference setting and for outputting the filtered betting data to the user; and
receiving a betting request from the user.

31. A user terminal for use in a betting system for allowing a user to place a bet on the outcome of a contest, the user terminal comprising:
means for receiving contest data indicative of the progress of the contest and betting data from a communications channel;
means for outputting the contest data received from the communications channel to the user;
selecting means responsive to an input from the user for selecting a betting preference setting;
means for filtering the received betting data in dependence upon the selected betting preference setting and for outputting the filtered betting data to the user; and
means for receiving a betting request from the user.

32. A user terminal for use in a race simulation system for generating a simulation of a race between a plurality of participants which move from a start position to an end position on a racing course, the user terminal comprising:
means for receiving positional data for each of the participants as they move from the start position to the end position during the race, from a communications channel;
means for storing data defining the layout of the racing course; and
means for generating and for outputting a simulation of the race using the received positional data and the stored layout data.

33. A user terminal according to claim 32, wherein said stored layout data comprises a 3D model of the racing course.

34. A transmission system for use in a race simulation system for generating a simulation of a race between a plurality of participants which move from a start position to an end position on a racing course, the transmitter comprising:
means for tracking the position of the participants as they move from the start position to the end position and for generating corresponding positional data for each of the participants; and
transmitting means for transmitting said positional data to a communications channel for transmission to one or more remote users.

35. A signal conveying processor implementable instructions for instructing a processor to implement the method according to claim 20.

36. A storage medium storing processing implementable instructions for instructing a processor to implement the method according to claim 20.

37. Processor implementable instructions for causing a processor to implement the method according to claim 20.

38. A signal conveying processor implementable instructions for instructing a processor to implement the method according to claim 30.

39. A storage medium storing processing implementable instructions for instructing a processor to implement the method according to claim 30.

40. Processor implementable instructions for causing a processor to implement the method according to claim 30.
